(19) United States
(12) Patent Application Publication
(10) Pub. No.: US 2025/0149194 A1
(43) Pub. Date: May 8, 2025

(54) NUCLEAR REACTOR SHIELDING FACILITY, NUCLEAR FACILITY, AND NUCLEAR REACTOR SHIELDING FACILITY CONSTRUCTION METHOD

(71) Applicant: MITSUBISHI HEAVY INDUSTRIES, LTD., Tokyo (JP)

(72) Inventors: Hiroaki Yamamoto, Tokyo (JP); Keiji Yamashita, Tokyo (JP); Satoru Kamohara, Tokyo (JP); Tadakatsu Yodo, Tokyo (JP); Shohei Otsuki, Tokyo (JP); Shota Kobayashi, Tokyo (JP); Yutaka Tanaka, Tokyo (JP); Tatsuo Ishiguro, Tokyo (JP); Hironori Noguchi, Tokyo (JP)

(73) Assignee: MITSUBISHI HEAVY INDUSTRIES, LTD., Tokyo (JP)

(21) Appl. No.: 18/837,969

(22) PCT Filed: Jan. 13, 2023
(86) PCT No.: PCT/JP2023/000815

§ 371 Date: Aug. 13, 2024

(30) Foreign Application Priority Data
Feb. 25, 2022 (JP) 2022-028116

(51) Int. Cl. G21C 11/02; G21C 15/02; G21F 1/02; G21F 1/08; G21F 1/10

(52) U.S. Cl. CPC G21C 11/028; G21C 15/02; G21F 1/023; G21F 1/08; G21F 1/10

(57) ABSTRACT

An easy-to-construct nuclear reactor shielding facility with robust shielding against ionizing radiation is provided. This nuclear reactor shielding facility is a nuclear reactor shielding facility for shielding a nuclear reactor installed on an installation surface by enclosing the nuclear reactor, and includes: a base structure that is disposed around an outer surface of the nuclear reactor except for the installation surface, and encloses an entire surface of the nuclear reactor except for the installation surface; and a shielding structure that is disposed on an entire surface of the base structure and internal of which is filled with water.

### FIELD

The present disclosure relates to a nuclear reactor shielding facility and a shielding facility construction method.

### BACKGROUND

In nuclear facilities that use a nuclear fuel and utilize the heat from the nuclear fissions, the nuclear fuel that goes through the nuclear fissions is stored inside a nuclear reactor. There are some nuclear power generation systems that generate power using the heat resultant of nuclear fissions. In such a nuclear power generation system, the heat generated in a nuclear reactor is recovered in a primary cooling system where primary coolant is circulated, between the nuclear reactor and a secondary cooling system. Heat exchange is then carried out between the primary coolant and secondary coolant, and a turbine provided to the secondary cooling system is rotated to generate power using the energy of the secondary coolant. The nuclear reactor in the nuclear power generation system is enclosed in a containment, and the containment is further covered with a reactor building built with a material such as concrete. One example of the building for enclosing a fuel storage vessel for storing spent nuclear fuels is disclosed in Patent Literature 1. The building disclosed in Patent Literature 1 has a wall surface on which a structure filled with water is disposed.

### CITATION LIST

### Patent Literature

Patent Literature 1: Japanese Patent No. 3601046

### SUMMARY

### Technical Problem

Recently, as a power generation facility or the like using a nuclear reactor, a facility that uses a relatively small nuclear reactor has come to be developed. If such a small nuclear reactor is to be shielded with a structure made of a metal or thick concrete providing robust shielding, construction of the entire facility become burdensome.

The present disclosure is to address such an issue, and an object of the present invention is to provide a nuclear reactor shielding facility, a nuclear facility, and a nuclear reactor shielding facility construction method for enabling easier construction, while ensuring robust shielding against ionizing radiation.

### Solution to Problem

To achieve the above-described object, a nuclear reactor shielding facility according to an aspect of the present disclosure is for shielding a nuclear reactor installed on an installation surface by enclosing the nuclear reactor, and includes: a base structure that is disposed around an outer surface of the nuclear reactor except for the installation surface, and encloses an entire surface of the nuclear reactor except for the installation surface; and a shielding structure that is disposed on an entire surface of the base structure and internal of which is filled with water.

To achieve the above-described object, a nuclear facility according to an aspect of the present disclosure includes: a nuclear reactor; and the above-described nuclear reactor shielding facility.

To achieve the above-described object, a nuclear reactor shielding facility construction method according to an aspect of the present disclosure includes the steps of: installing a base structure around a nuclear reactor installed on an installation surface; disposing a container on an entire surface of the base structure; and filling water inside the container.

### Advantageous Effects of Invention

According to the present disclosure, it is possible to make construction easier, while ensuring robust shielding against ionizing radiation, advantageously.

### BRIEF DESCRIPTION OF DRAWINGS

FIG. 1 is a schematic illustrating a general structure of a nuclear facility according to an embodiment.

FIG. 2 is a schematic illustrating a general structure of a nuclear power generation system according to the embodiment.

FIG. 3 is a schematic illustrating one example of a nuclear reactor shielding facility manufacturing method according to the embodiment.

FIG. 4 is a schematic illustrating another example of the nuclear reactor shielding facility.

FIG. 5 is a schematic illustrating a general configuration of a nuclear facility according to another embodiment.

### DESCRIPTION OF EMBODIMENTS

Some embodiments according to the present disclosure will now be explained in detail with reference to the drawings. These embodiments are, however, not intended to limit the scope of the present invention in any way. The components described in the following embodiments include those that are replaceable by those skilled in the art or those that are substantially identical.

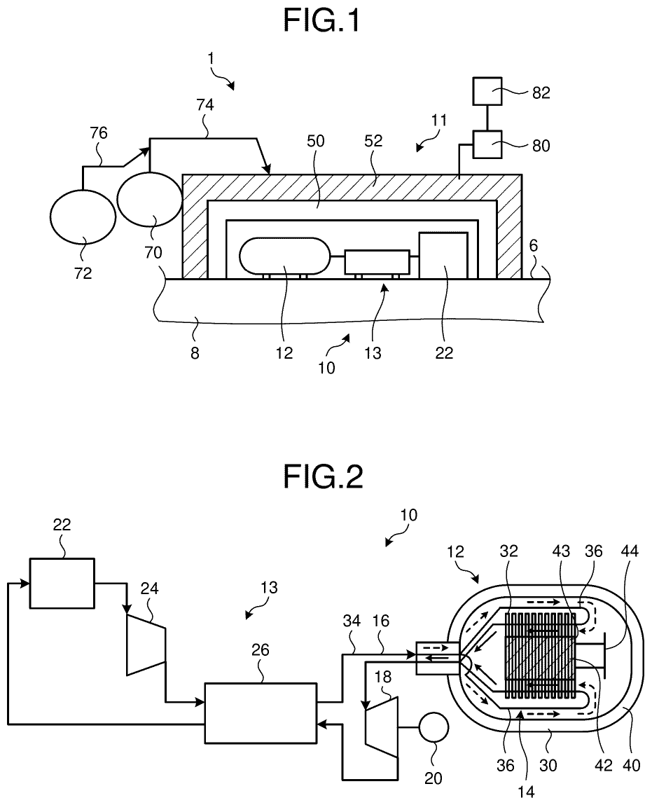

FIG. 1 is a schematic illustrating a general structure of a nuclear power generation facility according to an embodiment. The nuclear facility illustrated in FIG. 1 will be explained using an example of a nuclear power generator, by which the power is generated using the heat generated in the nuclear reactor, but the present disclosure is not limited thereto. This nuclear facility is also applicable as a facility that uses the heat generated in the nuclear reactor for purposes other than power generation. The nuclear facility is also applicable as a facility that manufactures a radioactive substance using the ionizing radiation generated in the nuclear reactor. A nuclear facility 1 illustrated in FIG. 1 includes a nuclear power generation system 10 and a nuclear reactor shielding facility 11. The nuclear power generation system 10 is installed on an installation surface 6. The installation surface 6 according to the embodiment is a surface that is in contact with the foundation of a nuclear reactor, and is a surface of a ground 8. The nuclear reactor shielding facility 11 is disposed around the nuclear power generation system 10. The ground 8 and the nuclear reactor shielding facility 11 together enclose the entire nuclear power generation system 10. In other words, the nuclear power generation system 10 is housed inside the space enclosed by the ground 8 and the nuclear reactor shielding facility 11.

FIG. 2 is a schematic illustrating a general structure of the nuclear power generation system according to the embodiment. As illustrated in FIG. 2, the nuclear power generation system 10 includes a reactor unit 12 and a generator unit 13. The generator unit 13 includes a heat exchanger 14, a refrigerant circuit 16, a turbine 18, a generator 20, a cooler 22, a compressor 24, and a reheat exchanger 26.

The reactor unit 12 includes a nuclear reactor 30 and thermal conductors 32. The nuclear reactor 30 includes a reactor vessel 40, a core fuel 42, and a control unit 44. The reactor vessel 40 stores therein the core fuel 42. The reactor vessel 40 stores therein the core fuel 42 in a sealed fashion. The reactor vessel 40 has an opening and closing portion so that the core fuel 42 to be placed in the reactor vessel 40 can be inserted and removed thereto and therefrom. An example of the opening and closing portion includes a lid. The reactor vessel 40 can remain sealed even when nuclear fissions occur inside the reactor vessel 40 and the internal temperature and pressure rise. The reactor vessel 40 is made of a material capable of shielding from neutron beams, and has a thickness not causing any leakage of the neutron beams generated inside the reactor vessel 40 to the outside. The reactor vessel 40 is made of metal, for example. It is also possible for the material of the reactor vessel 40 to include an element with robust shielding, such as boron.

The core fuel 42 includes a plurality of fuel support plates 43. Inside each of the fuel support plates 43, a plurality of nuclear fuels are disposed. The fuel support plates 43 are made of a material that transfers heat generated by the nuclear fuels. For the fuel support plates 43, graphite, silicon carbide, or the like may be used. The core fuel 42 generates reaction heat as a result of nuclear fissions of the nuclear fuels.

The control unit 44 includes shielding members that can be moved into the space between lumps of the core fuel 42. The shielding members are what is called control rods with a function for suppressing nuclear fissions by shielding from the ionizing radiation. The nuclear reactor 30 controls the reaction of the core fuel 42 by causing the control unit 44 to move to adjust the position of the shielding members.

The thermal conductors 32 are disposed inside of the reactor vessel 40, as illustrated in FIG. 2, and is in contact with the fuel support plates 43. The thermal conductors 32 according to this embodiment are a plurality of plate-like members, and are structured such that these plates are stacked alternately with the fuel support plates 43. The thermal conductors 32 are plates having external shapes of which are larger than those of the fuel support plates 43, and project out to a space without the fuel support plates 43. For the thermal conductors 32, materials such as titanium, nickel, copper, graphite, or graphene may be used. For the thermal conductors 32, in order to enable the heat to be conducted more efficiently to these projecting portions, it is preferable to use graphene, by disposing the graphene in an orientation enabling the heat to be conducted efficiently in directions across the plate surface. The thermal conductors 32 conduct heat via solid thermal conduction. In other words, the thermal conductors 32 conduct heat without using any heat medium (fluid). Specifically, the thermal conductors 32 conduct heat generated by the core fuel 42 to the generator unit 13 via solid thermal conduction.

The reactor unit 12 has the configuration described above, in which the core fuel 42 goes through nuclear fissions inside the nuclear reactor 30, and generates reaction heat. The generated heat is contained inside the reactor vessel 40, and increases the temperature inside the reactor vessel 40. In the reactor unit 12, part of heat generated in the nuclear reactor 30 is transferred to the thermal conductors 32. The thermal conductors 32 heat the refrigerant flowing through the refrigerant circuit 16 included in the generator unit 13. As the refrigerant, carbon dioxide (CO₂) is preferably used.

The refrigerant circuit 16 includes a circulation path 34 circulating outside of the reactor vessel 40, and a heat exchanging portion 36 circulating inside of the reactor vessel 40. The circulation path 34 and the heat exchanging portion 36 together form a closed loop, and circulate. The circulation path 34 is a path for circulating the refrigerant outside the reactor vessel 40, and the turbine 18, the cooler 22, the compressor 24, and the reheat exchanger 26 are connected to the circulation path 34. The heat exchanging portion 36 is inserted into and rests inside the reactor vessel 40. Both ends of the heat exchanging portion 36 are exposed outside of the reactor vessel 40, and are connected to the circulation path 34. The heat exchanging portion 36 is a conduit for circulating the refrigerant, and is in contact with parts of the thermal conductors 32 not in contact with the core fuel 42. In other words, the heat exchanging portion 36 is in contact with the projecting portions of the thermal conductors 32, projecting outside of the core fuel 42. The heat exchanging portion 36 heats the refrigerant by exchanging heat with the thermal conductors 32. In this embodiment, the heat exchanging portion 36 and the thermal conductors 32 serve as the heat exchanger 14.

The refrigerant flowing through the refrigerant circuit 16 is supplied into the heat exchanging portion 36. In the nuclear reactor power generation system 10, the thermal conductors 32 exchange heat with the refrigerant supplied through the refrigerant circuit 16. The heat exchanger according to this embodiment is configured with the thermal conductors 32 and the heat exchanging portion 36 of the refrigerant circuit 16. The heat exchanger recovers the heat from the thermal conductors 32, using the refrigerant flowing through the refrigerant circuit 16. In other words, the refrigerant is heated by the thermal conductors 32. The heat medium heated by the heat exchanging portion 36 flows through the turbine 18, the cooler 22, the compressor 24, and the reheat exchanger 26, in the order listed herein. The refrigerant passed through the reheat exchanger 26 is supplied to the heat exchanging portion 36 again. In the manner described above, the refrigerant is circulated through the refrigerant circuit 16.

The refrigerant passed through the heat exchanger 14 flows into the turbine 18. The turbine 18 is then rotated by the energy of the heated refrigerant. In other words, the turbine 18 absorbs the energy from the refrigerant, by converting the energy of the refrigerant into a rotational energy. The generator 20 is coupled to the turbine 18, and is rotated integrally with the turbine 18. The generator 20 generates power by being rotated with the turbine 18.

The cooler 22 cools the refrigerant passed through the turbine 18. Examples of the cooler 22 include a chiller, and a condenser when the refrigerant is temporarily liquefied. The compressor 24 is a pump that compresses the refrigerant. In the reheat heat exchanger 26, heat is exchanged between the refrigerant passed through the turbine 18 and the refrigerant passed through the compressor 24. The reheat heat exchanger 26 heats the refrigerant passed through the compressor 24, using the refrigerant passed through the turbine 18. In other words, the reheat heat exchanger 26 recovers the heat to be removed in the cooler 22, using the refrigerant to be supplied to the reactor unit 12, by allowing the refrigerant before being cooled by the cooler 22 to exchange heat with the refrigerant after being cooled by the cooler 22.

In the nuclear power generation system 10, the heat generated by the reactions of the nuclear fuels inside the nuclear reactor 12 is transferred to the refrigerant inside the heat exchanging portion 36 via the thermal conductors 32, to heat the refrigerant flowing through the refrigerant circuit 16 using the heat of the thermal conductors 32. In other words, the refrigerant absorbs the heat transferred via the thermal conductors 32. With this, the heat generated in the nuclear reactor 12 is transferred via the solid thermal conduction of the thermal conductors 32, and recovered by the refrigerant. The refrigerant is compressed by the compressor 24, and heated while passing across the thermal conductors 32. The turbine 18 is then rotated by the energy of the compressed and heated refrigerant. The refrigerant is then cooled in the cooler 22 to a reference state, and then supplied to the compressor 24 again.

As described above, the nuclear reactor power generation unit 10 transfers the heat inside the nuclear reactor 30 to the refrigerant that is a medium for rotating the turbine 18, using the thermal conductors 32, which conduct heat via solid thermal conduction.

By using carbon dioxide as the refrigerant, the nuclear reactor power generation unit 10 can inhibit contamination of the refrigerant even when the refrigerant is circulated inside the nuclear reactor 30. In this manner, it is possible to suppress the risk of contaminating the medium for rotating the turbine 18. Furthermore, by providing the thermal conductors 32 that transfer heat via solid thermal conduction, the thermal conductors 32 can achieve shielding from neutron beams.

It is preferable for the reactor vessel 40 to be made of a material that is less thermally conductive than the thermal conductor 32. With such a configuration, it is possible to suppress the release of the heat in the nuclear reactor 30 to the outside, via parts other than the thermal conductor 32 forming the path for releasing heat to the outside.

The nuclear reactor shielding facility 11 is disposed around the nuclear reactor power generation system 10. The nuclear reactor shielding facility 11 according to the embodiment covers the sides and the top of the nuclear reactor power generation system 10, that is, the surfaces other than the surface in contact with the installation surface 6. The nuclear reactor shielding facility 11 includes a base structure 50, a shielding structure 52, a water tank 70, a polymer container 72, a water supply line 74, a polymer supply line 76, a water content detecting unit 80, and a filling control unit 82.

The base structure 50 is a permanent structure made of concrete, for example. The base structure 50 is disposed in a manner enclosing the nuclear reactor power generation system 10. The base structure 50 may be any structure satisfying the strength requirements as a structure disposed around the nuclear reactor 30. The base structure 50 may be made of a material and have a thickness not satisfying shielding requirements as the structure surrounding the reactor.

The shielding structure 52 is a structure internal of which is filled with water and polymer. In other words, the shielding structure 52 includes a structure having an internal space, and water and polymer filled inside the structure. The shielding structure 52 is disposed around the entire outer surface of the base structure 50, that is, on the entire surface facing the opposite side of the space where the nuclear reactor 30 is disposed. The shielding structure 52 with the internal space may be made of various materials. For example, the structure having the internal space may be made of metal.

The polymer filled in the shielding structure 52 is a highly polymerized processed substance that absorbs water, that is, a highly polymerized processed substance that forms a hydrate. As the polymer, sodium polyacrylate may be used. The shielding structure 52 may have the water inside the shielding structure 52 entirely absorbed by the polymer or not absorbed by the polymer.

In the shielding structure 52, water or polymer having absorbed water is disposed on the entire outer surface of the base structure 50 at a thickness that satisfies the shielding requirements. The thickness of the shielding structure 52 may vary depending on how the nuclear reactor 30 and the base structure 50 are designed, but preferably, for example, the shielding structure 52 is a structure having such thicknesses of the base structure 50 and water that the resultant radiation dose on the outer surface of the shielding structure 52 satisfies a regulatory requirement.

The water tank 70 is a container filled with water. The polymer container 72 is a container filled with polymer. The water supply line 74 connects the water tank 70 to the shielding structure 52. The shielding structure 52 has a joint to be connected with the water supply line 74. The joint may have a structure that is removable from the water supply line 74, and is closed by a lid or the like while the water supply line 74 is not connected thereto. The polymer supply line 76 connects the polymer container 72 to the water supply line 74. The polymer supply line 76 supplies polymer into the water supply line 74.

The water content detecting unit 80 detects the water content in the shielding structure 52. The water content detecting unit 80 may have any configuration capable of detecting the water content of the shielding structure 52. For example, in a configuration in which the shielding structure 52 is filled with water, a water level may be used. The water content detecting unit 80 may also detect the water content using a hygrometer. The water content detecting unit 80 may also measure the water content retained in the shielding structure 52 by measuring the shape of the polymer using a ranging sensor or the like.

Based on the filling control unit 82 and the detection result of the water content detecting unit 80, the timing and the amounts by which the water and the polymer are supplied into the shielding structure 52 are controlled. When the water content is determined to be lower than a threshold, the filling control unit 82 supplies the water to the shielding structure 52 from the water tank 70.

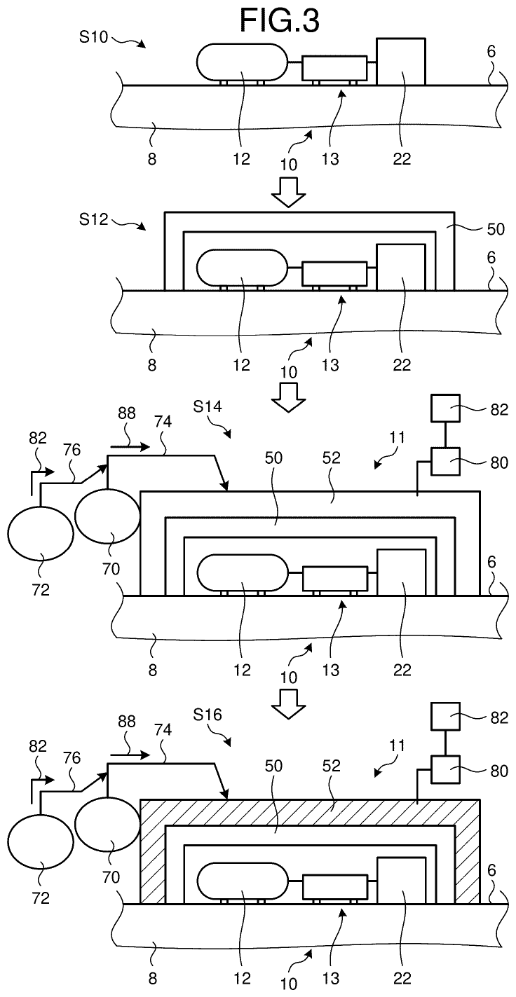

A nuclear reactor shielding facility manufacturing method will now be explained with reference to FIG. 3. FIG. 3 is a schematic illustrating one example of the nuclear reactor shielding facility manufacturing method according to the embodiment. As indicated at Step S10, the nuclear power generation system 10 is installed on the installation surface 8. As indicated at Step S12, the base structure 50 is then installed around the nuclear power generation system 10. As indicated at Step S14, a structure having an internal space is then built on the surface of the base structure 50, as a part of the shielding structure 52. As indicated at Step S16, water and polymer are then filled inside the structure having the internal space, by supplying the polymer from the polymer container 72 (arrow 82) while supplying water from the water tank 70 (arrow 80). As a result, the shielding structure 52 internal of which is filled with the water and the polymer is created.

By disposing the shielding structure 52 around the entire outer surface of the base structure 50, and filling inside of the shielding structure 52 with the water and the polymer, the nuclear reactor shielding facility 11 is enabled to shield the nuclear reactor 30, suitably. By disposing the shielding structure 52 on the entire outer surface of the base structure 50, leakage of the ionizing radiation from the space between the members of the shielding structure 52 can be suppressed. Furthermore, by disposing the shielding structure 52 on the entire area not shielded by the ground, it is possible to shield from the ionizing radiation using water. In this manner, by filling water at the time of constructing the nuclear reactor shielding facility 11, the nuclear reactor shielding facility 11 can be provided with robust shielding capability, and constructed easily. In other words, it is possible to construct the nuclear reactor shielding facility 11 without requiring building or transportation of solid or the like with robust shielding capability. Furthermore, when the nuclear reactor shielding facility 11 is to be taken down, the part implementing the shielding function can be removed by removing the water and the polymer filled inside.

In the exemplary nuclear reactor shielding facility 11 illustrated in FIG. 3, polymer is supplied with water into a hollow structure; however, the order in which the polymer and the water are supplied is not limited thereto. For example, the polymer may be supplied into the hollow structure at first, and the water may follow.

By disposing polymer inside the shielding structure 52, the nuclear reactor shielding facility 11 can facilitate adjustment of how liquid water is positioned. Furthermore, water leakage can be suppressed. Although it is preferable for the nuclear reactor shielding facility 11 to be filled with polymer, the nuclear reactor shielding facility 11 may also be filled with water in the liquid state, for example.

Because the nuclear reactor shielding facility 11 according to this embodiment is provided with the water content detecting unit 80 and the filling control unit 82, the water content inside the nuclear reactor shielding facility can be adjusted while ensuring robust shielding capability. However, without limitation thereto, the nuclear reactor shielding facility 11 may have a structure for which no measurement nor filling are carried out. Furthermore, it is also possible to fill a certain amount of water once in every lapse of a certain time interval.

Although the nuclear reactor shielding facility 11 according to this embodiment has a structure including the water tank 70, the polymer container 72, the water supply line 74, and the polymer supply line 76, the water tank 70, the polymer container 72, the water supply line 74, or the polymer supply line 76 in the nuclear reactor shielding facility 11 may be omitted. In other words, a mechanism for supplying water and polymer may be provided only during the construction of the shielding structure 52, and removed subsequently. With this, it is possible to use the mechanism for supplying water and polymer for construction of a plurality of the shielding structures 52.

Furthermore, in the nuclear facility 1, the nuclear reactor 30 configured to transfer the heat of the core fuel via solid thermal conduction, as disclosed in the embodiment, can achieve a relatively small facility; therefore, an easy-to-construct shielding structure, such as the nuclear reactor shielding facility 11, can be used suitably.

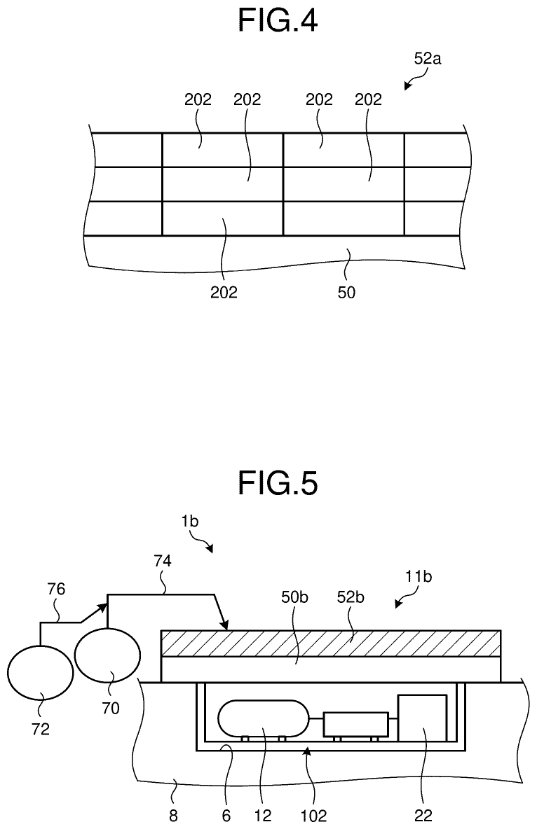

FIG. 4 is a schematic illustrating another example of the nuclear reactor shielding facility. The nuclear reactor shielding facility may have the shielding structure divided into a plurality of sections. In a shielding structure 52a illustrated in FIG. 4, the external region of the base structure 50 is divided into a plurality of sections 202. Each of the sections 202 forms a closed space, and is partitioned by walls. The shielding structure 52a is divided into a plurality of sections in each of the thickness and the width directions.

With the shielding structure 52a divided into the sections 202, water can be filled in each of such sections, and the amount of the water (the thickness in the shielding direction) can be adjusted at each position. Furthermore, the shielding structure 52a may be provided with a coupler for supplying water into each of the sections 202, or may have a structure in which the sections 202 are coupled to one another. Furthermore, although in the example illustrated in FIG. 4, the wall surfaces of the sections 202 are aligned with one another, the wall surfaces may also be positioned offset with respect to one another. With this configuration, the positions of the wall surfaces not filled with water can be offset with respect to one another, so that the shielding capability can be further improved.

FIG. 5 is a schematic illustrating a general configuration of a nuclear facility according to another embodiment. In the nuclear reactor facility illustrated in FIG. 5, the installation surface 6 of the nuclear power generation system 10 is formed inside a basement 102 formed by digging the ground 8. A nuclear reactor shielding facility 11b is then disposed on top of the nuclear power generation system 10. The bottom surface and the side surfaces of the nuclear power generation system 10 are shielded by the ground 8, and the top surface is shielded by the nuclear reactor shielding facility 11b. The nuclear reactor shielding facility 11b serves as a lid of the basement 102. A base structure 50b and a shielding structure 52b are included in the nuclear reactor shielding facility 11b.

This nuclear facility 1b can shield the nuclear reactor 30 with the ground 8 and the nuclear reactor shielding facility 11b. By installing the nuclear reactor 30 in the basement, as in this example, it is possible to use a structure in which the nuclear reactor shielding facility 11b is provided only on the top. In this manner, the structure can be simplified.

In the nuclear facility 1 according to the embodiment, by disposing the entire nuclear reactor power generation system 10 in the space enclosed by the ground 8 and the nuclear reactor shielding facility 11, the units can be disposed efficiently. The nuclear reactor including the nuclear fuel is the only component required to be disposed inside the space enclosed by the ground 8 and the nuclear reactor shielding facility 11 in the nuclear facility 1, and other components of the nuclear facility 1 may be disposed outside of the space enclosed by the ground 8 and the nuclear reactor shielding facility 11. In other words, the nuclear reactor shielding facility 11 only needs to surround the nuclear reactor 30, and to have the nuclear reactor 30 disposed inside the space formed with the installation surface 6. Hence, the components of the generator unit 13 may be disposed outside the nuclear reactor shielding facility 11.

In this embodiment, the refrigerant circuit 16 is inserted into the reactor vessel 40. However, the configuration is not limited thereto. The refrigerant circuit 16 may also have a structure in which the thermal conductors 32 transferring heat via solid thermal conduction penetrate and project out of the reactor vessel 40.

### REFERENCE SIGNS LIST

1 Nuclear facility
6 Installation surface
8 Ground
10 Nuclear power generation system
11 Nuclear reactor shielding facility
12 Reactor unit
13 Generator unit
14 Heat exchanger
16 Refrigerant circuit
18 Turbine
20 Generator
22 Chiller (cooler)
24 Pump (compressor)
26 Regenerative heat exchanger
30 Nuclear reactor
32 Thermal conductor
34 Circulation path
36 Heat exchanging portion
40 Reactor vessel
42 Core fuel
43 Fuel support plate
44 Control unit
50 Base structure
52 Shielding structure
70 Water tank
72 Polymer container
74 Water supply line
76 Polymer supply line
80 Water content detecting unit
32 Filling control unit

1. A nuclear reactor shielding facility for shielding a nuclear reactor installed on an installation surface by enclosing the nuclear reactor, the nuclear reactor shielding facility comprising:
a base structure that is disposed around an outer surface of the nuclear reactor except for the installation surface, and encloses an entire surface of the nuclear reactor except for the installation surface; and
a shielding structure that is disposed on an entire surface of the base structure and internal of which is filled with water.

2. The nuclear reactor shielding facility according to claim 1, wherein the shielding structure is disposed on an opposite surface of the base structure, the opposite surface being an opposite side of a surface facing the reactor.

3. The nuclear reactor shielding facility according to claim 1, wherein the shielding structure stores therein a polymer compound that absorbs water.

4. The nuclear reactor shielding facility according to claim 1, wherein the shielding structure is divided into a plurality of sections.

5. The nuclear reactor shielding facility according to claim 1, wherein the shielding structure includes water filled inside a container that is made of metal.

6. The nuclear reactor shielding facility according to claim 1, wherein the shielding structure includes a filling mechanism capable of being opened and closed and of supplying water into the shielding structure.

7. The nuclear reactor shielding facility according to claim 6, further comprising a tank that is connected to the filling mechanism, and supplies the water into the shielding structure.

8. A nuclear facility comprising:
a nuclear reactor; and
the nuclear reactor shielding facility according to claim 1.

9. The nuclear facility according to claim 8, wherein
the nuclear reactor is disposed on an installation surface formed below a ground level in a vertical direction, and
the nuclear reactor shielding facility is disposed on an upper surface of the reactor in the vertical direction.

10. The nuclear facility according to claim 8, further comprising a generator unit that is disposed inside a space surrounded by the installation surface and the base structure, and generates power using heat generated in the reactor.

11. The nuclear facility according to claim 10, wherein
the nuclear reactor includes
a core fuel that is solid; and
a reactor vessel that surrounds to cover the core fuel and to shield a space having the core fuel for shielding against ionizing radiation, and
the generator unit includes
a thermal conductor that is provided to at least a part of the reactor vessel, and transfers heat inside the reactor vessel to external through solid thermal conduction;
a heat exchanger that enables the thermal conductor to exchange heat with refrigerant;
a refrigerant circuit that circulates the refrigerant passing through the heat exchanger;
a turbine that is rotated by the refrigerant circulating through the refrigerant circuit; and
a generator that is rotated integrally with the turbine.

12. A nuclear reactor shielding facility construction method comprising:
installing a base structure around a nuclear reactor installed on an installation surface;
disposing a container on an entire surface of the base structure; and
filling water inside the container.

13. The nuclear reactor shielding facility construction method according to claim 12, wherein the container is filled with water-absorbing polymer compound, as well as water.

14. The nuclear reactor shielding facility construction method according to claim 12, wherein a water-absorbing polymer compound is filled in the container before the water is supplied.
